(19) United States
(12) Patent Application Publication
(10) Pub. No.: US 2007/0045063 A1
(43) Pub. Date: Mar. 1, 2007

(54) Disc brake pad

(75) Inventors: Hisataka Naito, Tokyo (JP); Yukikazu Koyanagi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 11/511,478

(22) Filed: Aug. 29, 2006

(30) Foreign Application Priority Data
Aug. 31, 2005 (JP) P.2005-251206
Jun. 13, 2006 (JP) P.2006-163952

(51) Int. Cl. F16D 65/38

(52) U.S. Cl. 188/73.37; 188/250 E

(57) ABSTRACT

At four corners of a pressure plate 7, weights 15 are adhered an adhesive agent for high temperature use. When a frictional vibration is generated by frictionally engaging with a rotor in operating a brake, a shim 12 is displaced relative to a pressure plate 7 by inertia of the weight 14. Grease 13 between the shim 12 and the pressure plate 7 flows so as to produce a viscous resistance to a vibration of the shim 12 relative to the pressure plate 7. By the viscous resistance, the vibration of the pressure plate 7 is attenuated, as a result, brake squeal can be restrained from being brought about.

This application claims foreign priority from Japanese Patent Application Nos. 2005-251206 filed Aug. 31, 2005, and 2006-163952 filed on Jun. 13, 2006, the entire contents of which are hereby incorporated by reference.

### BACKGROUND OF THE INVENTION

1. Field of the Invention

The present invention relates to a disc brake used in a passenger vehicle, a truck, a bus, an industrial machine or the like.

2. Related Art

In a conventional disc brake for braking a rotating shaft by pressing a brake pad to a rotating rotor, there is a case in which when the pad brakes the rotating rotor or slides relative thereto, owing to a frictional vibration produced by frictionally engaging the rotor and the pad, the rotor or the brake parts are vibrated. When a frequency of the vibration is coincident with a natural frequency of the rotor or the brake parts, the vibration is brought into a resonance state by an eigenvalue coupled vibration. In a general brake, a function of absorbing a vibration frequency of squeal is weak and therefore, the resonance cannot be restrained and the brake squeal is generated.

There have been made a number of proposals as a countermeasure for preventing brake squeal of a disc brake. As one of the proposals, there has been proposed a disc brake in which attention is paid to vibration of a rotor (disc plate), a weight which can be moved along a direction in parallel with a rotating shaft of the disc plate is provided at inside of a space portion of the disc plate, and an elastic member is attached between the weight and an end of moving the weight (JP-A-07-167176). When the disc plate is vibrated, an urge force is generated at the elastic member by inertia of the weight, the urge force is operated in a direction reverse to a direction of vibrating the disc plate, the vibration of the disc plate is restrained to thereby restrain brake squealing.

Further, as an example of a countermeasure for preventing a brake squeal in a disc brake, there is a piston for the disc brake in which attention is paid to vibration of the piston constituting an operating mechanism, and a hollow cylindrical portion fitted into a cylinder, a wall portion disposed to be deviated to a pad pressing side end on an inner diameter side between both ends of the hollow cylindrical portion, and a projected portion projected from a side face of the wall portion for forming a dynamic damper are integrally formed by cast iron (refer to JP-A-10-122279). According to the piston for the disc brake, a value of a natural frequency of a caliper is set to a value capable of restraining brake squeal by adjusting a value of a natural frequency of the piston.

However, according to the countermeasure against brake squeal utilizing the space portion of the rotor, a type of the brake having the space portion is limited and therefore, the countermeasure is not a generally applicable. Further, although a restraining effect is achieved for a specific frequency of brake squeal, an effect is difficult to be expected generally for a frequency other than the specific frequency and a further improvement is requested in this respect.

Hence, there is posed a problem to be resolved in view of effectively restraining brake squeal by utilizing a viscous member and a weight.

### SUMMARY OF THE INVENTION

One or more embodiments of the present invention provide a disc brake pad capable of effectively preventing brake squeal by an inexpensive and simple structure by utilizing a viscous member and a weight.

In accordance with one or more embodiments of the present invention, a disc brake pad is provided with a lining; and a pressure plate attached with the lining, wherein a brake squeal is restrained by a viscous resistance by a flow of a grease and an inertia resistance by a weight.

According to the disc brake pad, the viscous resistance by the flow of the grease functions as a damper in correspondence with a speed of a vibration, the inertia resistance by the weight functions as a resistance in correspondence with a displacement of the vibration, and the brake squeal can be restrained by a synergistic effect of the two resistances.

The disc brake pad may further include a shim fixed on a side of the pressure plate opposed to the lining and coated with the grease between the pressure plate and the shim, wherein an outer side of the shim is arranged with the weight. In a type of combining the grease and the weight in this way, a noise restraining effect is achieved over a broad frequency band.

The disc brake pad may further include an auxiliary shim fixed on the side of the pressure plate opposed to the lining, in which the grease is coated between the shim and the auxiliary shim. According to the disc brake pad of the type, not only the noise restraining effect is achieved over the broad frequency band but also the shim and the auxiliary shim and the grease can summerizingly be handled since the grease is interposed between the shim and the auxiliary shim, particularly, handling of the grease having a fluidity is convenient.

In the disc brake pad, the weight may be arranged at a position in correspondence with a corner portion of the lining. The four corners of the lining are portions at which a magnitude of vibration in operating the brake is increased and therefore, a high damping effect can be achieved by arranging the weights at the corner portions.

In the disc brake pad, the grease may be sealed in a space portion formed at the pressure plate in a state of floating the weight. According to the type of the disc brake pad, the noise restraining effect is achieved over a broad frequency band.

In the disc brake pad, the space portion may be sealed by the shim fixed on the side of the pressure plate opposed to the lining. According to the type of the disc brake pad, the grease sealed at the space portion is made to be unable to flow out by the shim and therefore, the weight is not exposed to outside despite a simple structure, there is not a possibility of destruction or disintegration, and a permanent countermeasure can be established. Further, it is possible to provide the disc brake pad capable of preventing the grease from flowing out and also having continuance thereof.

In the disc brake pad, the space portion may be formed at a corner portion of the pressure plate. The four corners of the pressure plate are portions maximizing the magnitude of the vibration in operating the brake and therefore, by arranging the weights to the corner portions, the high damping effect can be achieved.

In the disc brake pad, the space portion of the pressure plate may be formed as a through hole penetrating the pressure plate, and the lining may be molded at a portion of the through hole. It is general for the pressure plate to form the through hole capable of molding the lining in order to promote a function of the lining constituting a friction member against shear, and the through hole can be utilized as it is as a space of sealing the grease and the weight.

Since the grease and the lining are brought into contact with each other at the space portion in accordance with one or more embodiments of the present invention, it is preferable to provide permeation preventing means for preventing permeation of the grease to the lining by blocking between the lining and the grease. By blocking the grease and the lining, an influence of the lining owing to permeation of the grease to the lining can be prevented beforehand.

Further, the permeation preventing means for preventing permeation of the grease to the lining may be provided at the space portion, or, a capsule for sealing the weight and the grease and mounted to the space portion, or a partitioning plate mounted to the space portion in a mode of partitioning between the lining and the grease. The coating layer, the capsule or the partitioning plate blocks between the grease and the lining to thereby prevent permeation of the grease to the lining.

In accordance with one or more embodiments of the present invention, by providing the pad having a comparatively large friction vibration with a damper structure combined with two functions of the viscous resistance and the inertia resistance, the vibration of the brake can effectively be absorbed and the brake squeal can be restrained. Since the viscous resistance of the grease is utilized, a noise restraining effect is achieved by absorbing the vibration having the broad frequency. Therefore, the invention is optimum for an emergency countermeasure or a confirming test in emitting a noise. Further, according to one or more embodiments, owing to a simple structure of only adding the weight to the shim and the grease which are normally used, also an increase in cost can be minimized. Further, according to one or more embodiments, the weight is arranged and the grease is sealed at the space portion at inside of the pressure plate of the pad and therefore, while absorbing the vibration of the broad frequency, the weight is not exposed to outside, there is not a danger of destruction or disintegration and therefore, the permanent countermeasure can be established. When there is a possibility of bringing the grease and the lining into contact with each other at the space portion formed at the pressure plate, by providing the permeation preventing means for preventing permeation of the grease to the lining, the influence of denaturing, the reduction in the strength, and the reduction in the function of the lining owing to permeation of the grease can be prevented beforehand.

Other aspects and advantages of the invention will be apparent from the following description and the appended claims.

### BRIEF DESCRIPTION OF THE DRAWINGS

FIG. 1 is a view showing a state that a disc brake pad of an exemplary embodiment of the present invention is applied as an outer pad.

FIG. 2 is a view showing a state that the disc brake pad of the exemplary embodiment of the present invention is applied as an inner pad.

FIG. 3 is a sectional view taken along a line A-A of the disc brake pad shown in FIG. 1.

FIG. 4 is a sectional view showing a state of operating the disc brake pad shown in FIG. 2.

FIG. 5 is a sectional view of an exemplary embodiment in which an auxiliary shim is added to the disc brake pad shown in FIG. 3.

FIGS. 6(a) and 6(b) illustrate graphs showing a property of the disc brake pad of the type shown in FIG. 1 through FIG. 4.

FIG. 7 is a view showing other exemplary embodiment of a disc brake pad according to the invention.

FIG. 8 is a sectional view taken along a line B-B of FIG. 7.

FIGS. 9(a) and 9(b) illustrate graphs showing a property of the disc brake pad of the type shown in FIG. 7 and FIG. 8.

FIG. 10 is a partially sectional view showing an exemplary embodiment for preventing permeation of grease to a lining in a disc brake pad according to the invention.

FIGS. 11(a) and 11(b) illustrate partially sectional views showing other exemplary embodiment of preventing permeation of grease to a lining in a disc brake pad according to the invention.

FIGS. 12(a) and 12(b) illustrate partially sectional views showing still other exemplary embodiment of preventing permeation of grease to a lining in a disc brake pad according to the invention.

### DETAILED DESCRIPTION OF THE EXEMPLARY EMBODIMENTS

Exemplary embodiments of the invention will be described with reference to the accompanying drawings.

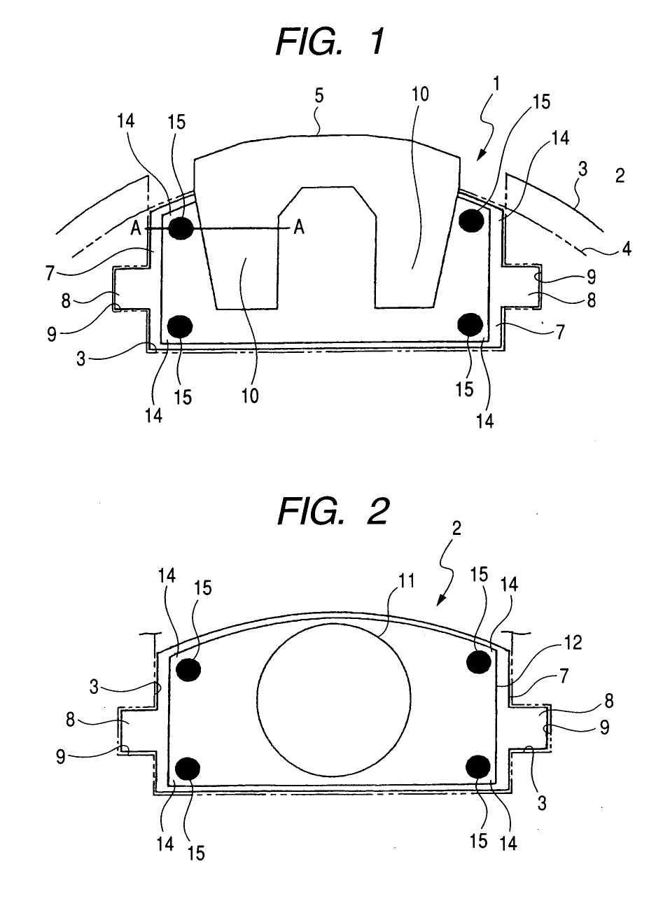

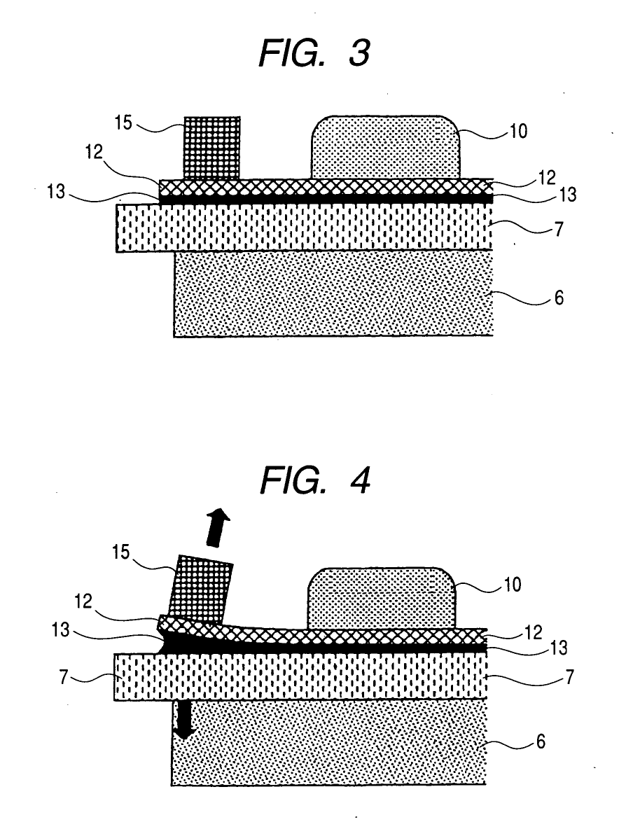

FIG. 1 is a view showing a state of applying a disc brake pad according to an exemplary embodiment of the invention as an outer pad, FIG. 2 is a view showing a state of applying a disc brake pad according to the exemplary embodiment as an inner pad, FIG. 3 is a sectional view taken along a line A-A of the disc brake pad shown in FIG. 1, FIG. 4 is a sectional view showing a state of operating the disc brake pad shown in FIG. 2.

A disc brake pad 1 shown in FIG. 1 is a pad arranged on an outer side, and is guided and supported by a fixing member 3 indicated by an imaginary line in directions of moving to and from a rotor 4 similarly indicated by an imaginary line. A caliper 5 including an operating mechanism and guided in directions of moving to and from the rotor 4 relative to the fixing member 3 is arranged to straddle the disc brake pad 1 and the rotor 4. On the outer side of the disc brake pad 1, a pair of caliper claw portions 10, 10 provided on a side opposed to a side of including the operating mechanism of the caliper 5 are brought into contact with a back face of a pressure plate 7 of the disc brake pad 1.

FIG. 2 shows a disc brake pad 2 arranged on an inner side, that is, on a side of an operating mechanism. The disc brake pad 2 shows a relationship of arranging with a piston 11 provided to the operating mechanism. The disc brake pad 2 on the inner side is substantially equivalent to the disc brake pad 1 on the outer side and a duplicated explanation thereof will be omitted.

FIG. 3 is a sectional view constituted by cutting a portion of the disc brake pad 1 on the outer side shown in FIG. 1 by an A-A section. The disc brake pad 1 includes a lining 6 pressed to the rotor 4 in operating the brake, and the pressure plate 7 pasted with the lining 6. By respectively fitting projected portions 8, 8 projected at the both sides of the pressure plate 7 to recess portions 9, 9 formed at the fixing member 2, the disc brake pad 1 is guided relative to the fixing member 3 in the directions of moving to and from the rotor 4.

A shim 12 comprising a metal plate having an outer shape line coinciding with a contour of the pressure plate 7 excluding the projected portion 8 in this example is arranged between the pressure plate 7 and the caliper claw portions 10, 10. The shim 12 can be fixed by the pressure plate 7 by pertinent means of, for example, a hook.

As shown in FIG. 3, a grease 13 having a high viscosity as a viscous substance is coated on a side of the pressure plate 7 of the shim 12, the shim 12 is mounted to the pressure plate 7 by interposing the grease 13 when applied to the disc brake pad 1.

As shown by FIG. 1, four corners 14 of the pressure plate 7 are respectively adhered with weights 15 by an adhesive for high temperature use. The weight 15 is made of iron, and can be constituted by a cubic member having a section of 10 mm, however, this is only an example and it is apparent that also a specification other than the cubic member can be constituted. When a frictional vibration is generated by a frictional engagement with the rotor 4 in operating the brake, the shim 12 is displaced relative to the pressure plate 7 as shown by FIG. 4 by inertia of the weight 14. At this occasion, the grease 13 present between the shim 12 and the pressure plate 7 flows as illustrated to generate a viscous resistance in a movement (vibration) of the shim 12 relative to the pressure plate 7. By the viscous resistance, the vibration of the pressure plate 7 is attenuated, as a result, brake squeal can be restrained from being brought about.

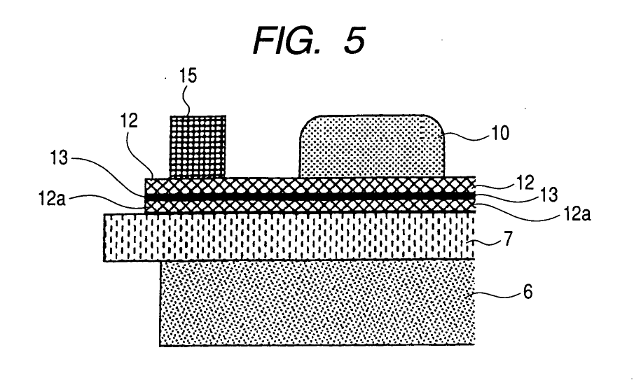

It is preferable to fix the weights 15 at the four corner portions 14 having large vibration in the shim 12. Because there are bending and torsional vibration modes, in both of the modes, vibration is large at the four corner portions. Although a number of the weights 15 is variably one or more, the larger the number of the plates 15 attached, the higher the effect of restraining brake squeal. Also in the disc brake pad 2 on the inner side, similar to the disc brake pad 1 on the outer side, it is preferable to provide the weights 15 at the four corner portions 14. Further, an auxiliary shim 12a (FIG. 5) may be provided between the pressure plate 7 and the shim 12 and the grease 13 may be interposed between the shim 12 and the auxiliary shim 12a. FIG. 5 is a sectional view of adding the auxiliary shim to FIG. 3. In this case, handling of the grease becomes simple and easy.

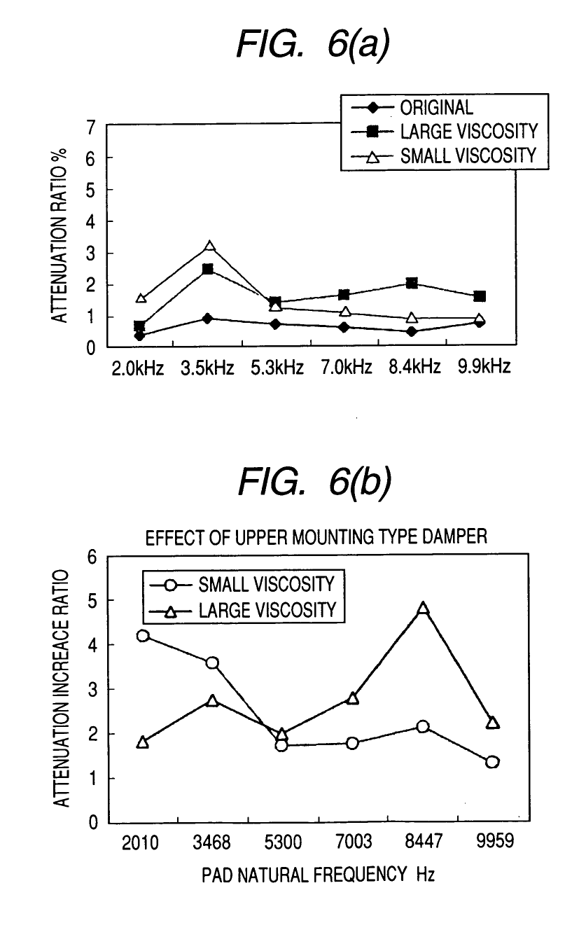

FIGS. 6(a) and 6(b) illustrate graphs showing a change in an attenuation ratio relative to the natural frequency of the pad of the disc brake pad having a number of the type shown in FIG. 1 through FIG. 4 by constituting a parameter by a viscosity of grease. As the parameters, a base (not using grease), small viscosity and large viscosity are used. As is known from FIG. 6 (a), when the viscosity is small, a damping effect is high at 5300 Hz or lower and when the viscosity is large, the damping effect is high at 5300 Hz or higher. In this way, since the viscous resistance of grease is utilized, the high damping effect can be achieved over a wide frequency range. Further, by adjusting the viscosity of grease, a frequency band having the high damping effect can be changed. Other than the viscosity of the grease, the frequency band having the damping effect can be adjusted by a weight or a shape of the weight. FIG. 6 (b) is a graph showing a change in an attenuation increase ratio (ordinate: attenuation ratio having damper/original attenuation ratio) relative to the pad natural value (abscissa). It has been found that there is an increase ratio of at least 1.2 multiplication factor, near to 5 multiplication factor in a larger one in any natural value.

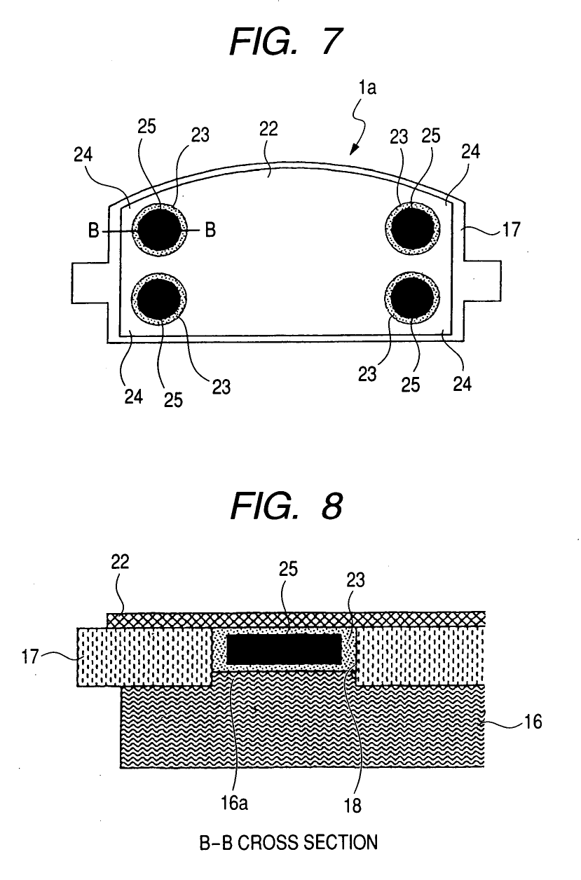

FIG. 7 and FIG. 8 are views showing other exemplary embodiment of a disc brake pad according to the invention. FIG. 7 is a view viewed from a shim, and FIG. 8 is a sectional view taken along a line B-B of FIG. 7. According to the exemplary embodiment shown in FIG. 7 and FIG. 8, a weight 25 is embedded in a mold hole 18 formed at a corner portion 24 of a pressure plate 17. The mold hole 18 is a hole utilized when a lining 16 is pasted on the pressure plate 17, and a portion of the lining 16 is attached thereto in a state of being brought into the mold hole 18. In operating the brake, a portion of a shear force exerted to the lining 16 is transmitted to the pressure plate 17 by way of a lining 16a brought into the mold hole 18 and therefore, a strength of attaching the lining 16 to the pressure plate 17 can be increased.

The grease or the weight for attenuating vibration in operating the brake can utilize the mold hole 18 used in pasting the lining 16 to the pressure plate 17. That is, at inside of the mold hole 18, a space thereof remaining after bringing the lining 16 thereinto is filled with the grease 23 and the weight 25 is embedded into the grease 23. A side of the mold hole 18 opposed to a side thereof for bringing the lining 16 thereinto is sealed by covering a back face side of the pressure plate 17 by a shim 22 to prevent the grease 23 from flowing out. Further, other than the corner portion 24 of the pressure plate 17, a hole for exclusively arranging the weight 25 may be formed.

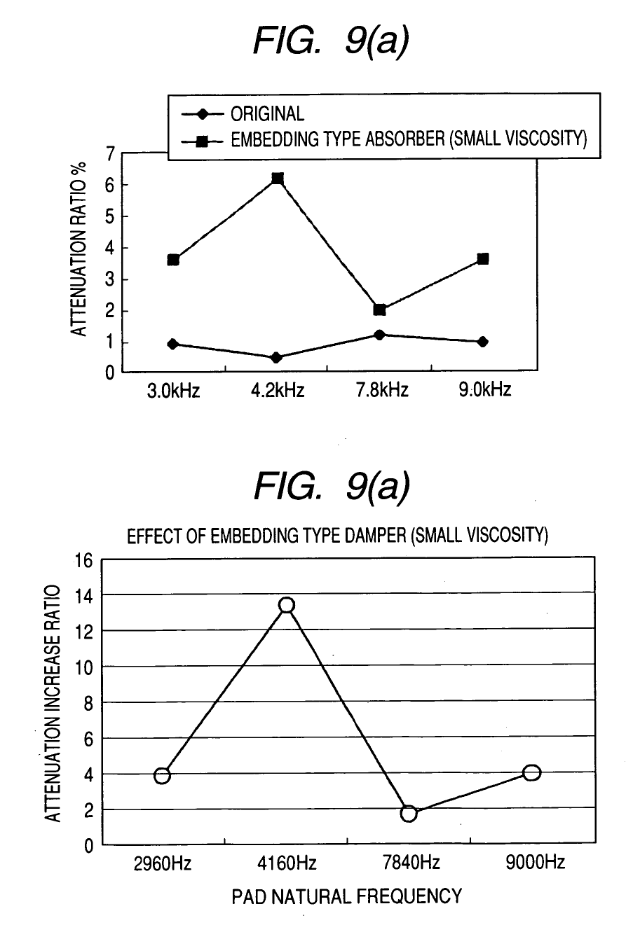

FIG. 9 (a) is a graph showing an attenuation ratio relative to several (four) frequencies of the original disc brake pad and the disc brake pad having a damping mechanism of a type shown in FIG. 7 and FIG. 8. It has been found that in any frequency which is heard as brake squeal, an attenuation ratio of the disc brake pad having the damping mechanism of the type indicates a significant value in comparison with the original disc brake pad. Further, FIG. 9 (b) is a graph showing a change in an attenuation increase ratio (ordinate: attenuation ratio having damper/original attenuation ratio) relative to a pad natural value (abscissa). It has been found that there is an increase in the ratio of at least 2 multiplication factor, 13 multiplication factor or more of a larger one in any natural value.

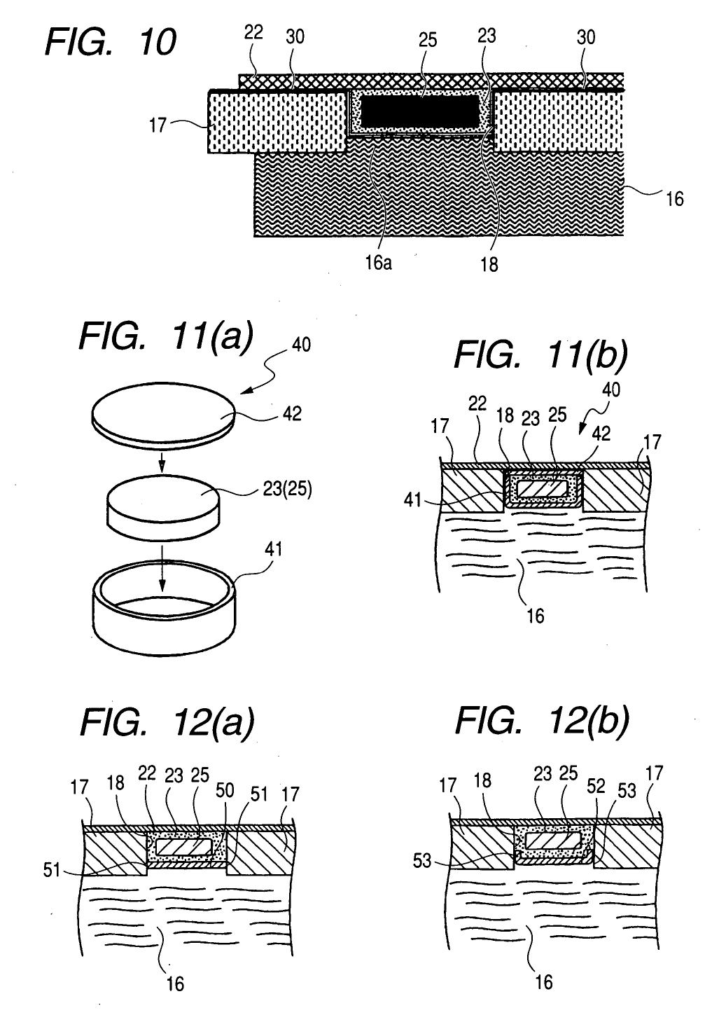

FIG. 10 shows an embodiment of preventing grease from impregnating to a lining of the disc brake pad according to the invention as a partial sectional view. The embodiment shown in FIG. 10 is provided with a coating layer 30 on the side of the pressure plate 17 opposed to the side of the lining 16 in the embodiment shown in FIG. 8. The coating layer 30 is extended to inside of the mold hole 18 constituting a space portion formed as a through hole at the pressure plate 17, and is coated on an inner peripheral face of the mold hole 18 and a surface of the lining 16 exposed to inside of the mold hole 18. Thereafter, the mold hole 18 is closed by filling the grease 23 into the mold hole 18 covered by the coating layer 30 and covering the back face side of the pressure plate 17 by the shim 22. The coating layer 30 is extended at least between the lining 16 and the grease 23 and therefore, functions as permeation preventing means for preventing permeation of the grease 23 to the lining 16 at inside of the mold hole 18 to thereby block permeation of the grease 23 to the lining 16. As a result, an influence of denaturing, a reduction in strength, and a reduction in function of the lining owing to permeation of the grease to the lining can be prevented beforehand.

FIGS. 11(a) and 11(b) illustrate views showing other exemplary embodiment for preventing permeation of grease to a lining according to a disc brake pad according to the invention. FIG. 11(a) is a disassembled view of a capsule. Fig. 11(b) is a sectional view of a state of applying the capsule to a space portion. Permeation preventing means shown in FIG. 11 is a capsule 40 comprising a case 41 constituting a cylindrical vessel, and a cap 42 for hermetically closing an opening of the case 41. Inside of the capsule 40 is filled with the weight 25 and the grease 23 for wrapping the weight 25 and is sealed by the cap 42. Inside of the mold hole 18 constituting the space portion formed as the through hole at the pressure plate 17 is mounted with the capsule 40 and is sealed by the shim 22. Further, although the cap 42 is pointed out as an example of hermetically sealing the one opening of the case 41 constituting a bottomed cylindrical member, there may be provided two caps for hermetically closing openings on both sides of a cylindrical barrel portion. It is preferable that inside of the capsule 40 is filled with the grease 23 and the weight 25 without leaving air. The capsule 40 blocks the grease 23 from leaking out to outside and therefore, permeation of the grease 23 to the lining 16 is prevented.

FIGS. 12(a) and 12(b) illustrate partially sectional views showing still other exemplary embodiment for preventing permeation of grease to a lining in a disc brake pad according to the invention. FIG. 12 (b) is a partially modified example of FIG. 12(a). Permeation preventing means shown in FIG. 12 (a) is a partitioning plate 50 for partitioning an interval between the lining 16 and the grease 23 in the mold hole 18 constituting the space portion formed as the through hole at the pressure plate 17. The mold hole 18 is filled with the weight 25 and the grease 23 wrapping the weight 25 and is sealed by the shim 22. The partitioning plate 50 is formed in a shape of fitting to the mold hole 18 and a peripheral end face 51 of the plate is fitted to the mold hole 18. Therefore, the partitioning plate 50 prevents the grease 23 from flowing to the line 16 to permeate to the lining 16. According to permeation preventing means shown in FIG. 12 (b), a peripheral edge portion 53 of a partitioning plate 52 is formed to be bent to a side of the grease 23 and is fitted to the mold hole 18. Therefore, according to the partitioning plate 52, the bent peripheral edge portion 53 is brought into contact with the mold hole 18 by a seal pressure and therefore, flow of the grease 23 to the side of the lining 16 can further effectively be blocked.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A disc brake pad comprising:
a lining;
a pressure plate attached with the lining; and
a weight,
wherein a brake squeal is restrained by a viscous resistance by a flow of a grease and an inertia resistance of the weight.

2. The disc brake pad according to claim 1, further comprising:
a shim fixed on a side of the pressure plate opposed to the lining and coated with the grease between the pressure plate and the shim, wherein the weight is arranged on an outer side of the shim.

3. The disc brake pad according to claim 2, further comprising:
an auxiliary shim fixed on the side of the pressure plate opposed to the lining, wherein the grease is coated between the shim and the auxiliary shim.

4. The disc brake pad according to claim 2, wherein the weight is arranged at a position in correspondence with a corner portion of the lining.

5. The disc brake pad according to claim 1, further comprising:
a space portion formed at the pressure plate, wherein the grease is sealed in the space portion, and the weight is floating in the grease.

6. The disc brake pad according to claim 5, wherein the space portion is sealed by a shim fixed on a side of the pressure plate opposed to the lining.

7. The disc brake pad according to claim 5, wherein the space portion is formed at a corner portion of the pressure plate.

8. The disc brake pad according to claim 5, wherein the space portion comprises a through hole penetrating the pressure plate, and the lining is molded at a portion of the through hole.

9. The disc brake pad according to claim 5, further comprising:
permeation preventing means for preventing permeation of the grease to the lining, provided at the space portion.

10. The disc brake pad according to claim 9, wherein the permeation preventing means comprises a coating layer provided at least between the lining and the grease from the side of the pressure plate opposed to the lining.

11. The disc brake pad according to claim 9, wherein the permeation preventing means comprises a capsule for sealing the weight and the grease and mounted to the space portion.

12. The disc brake pad according to claim 9, wherein the permeation preventing means comprises a partitioning plate mounted on the space portion for partitioning between the lining and the grease.
